(19) United States
(12) Patent Application Publication
(10) Pub. No.: US 2003/0093353 A1
(43) Pub. Date: May 15, 2003

(54) System and method for creating and maintaining investment portfolios

(75) Inventors: Blake D. Ward, Los Gatos, CA (US); Bruce L. Horn, Mammoth Lakes, CA (US)

Correspondence Address: Steven Sponseller, Stevens & Sponseller LLP, Suite 201, 99 North First Street, San Jose, CA, 95113, US

(73) Assignee: Marketocracy

(21) Appl. No.: 10/286,341

(22) Filed: Nov. 1, 2002

Related U.S. Application Data
(63) Continuation-in-part of application No. 09/610,160, filed on Jul. 5, 2000.

(51) Int. Cl. G06F 17/60

(52) U.S. Cl. 705/36

(57) ABSTRACT

An investment services architecture provides a suite of investment management tools and services to investors. The architecture includes an investment services hosting site that offers investment services to investors who access the services via the Internet using various investor computing devices. The architecture provides for the identification of a set of investment holdings associated with a first investment portfolio and identification of a set of investment holdings associated with a second investment portfolio. A ideal investment portfolio is created by merging the set of investment holdings associated with the first investment portfolio and the set of investment holdings associated with the second investment portfolio. Using the ideal investment portfolio, the architecture is able to suggest sales and purchases of holdings in an effort to achieve investment performance similar to the ideal investment portfolio.

### CROSS-REFERENCE TO RELATED APPLICATIONS

This application is a Continuation-In-Part of U.S. patent application Ser. No. 09/610,160, filed Jul. 5, 2000, which is incorporated by reference in its entirety herein.

### TECHNICAL FIELD

This invention relates to Internet-based systems and methods for maintaining and tracking financial investment portfolios. More particularly, this invention relates to systems and methods for creating and maintaining one or more ideal investment portfolios and leveraging those ideal investment portfolios to manage a real portfolio.

### BACKGROUND

There are approximately 8,000 professionally managed mutual funds in operation in the United States, and the number grows annually. Each year, approximately 80% of these funds fail to outperform the benchmark S&P 500 Index. The unsatisfactory performance of most mutual funds has spawned an entire class of Index Funds (i.e., funds that track various equity indexes, such as the S&P 500, the NASDAQ 100, the Russell 2000, etc.) as well as encouraged many investors to strike out on their own and manage their accounts rather than buy mutual funds.

The financial news media highlights the fund managers who have beaten the market over various lengths of time. Unfortunately, as the above statistic reveals, the number of fund managers who actually achieve this goal is small. Moreover, these star performers are drawn from a small field of professional fund managers who typically work for fund companies and earn a living investing client monies. There is no current way to identify superstar investors from the entire universe of all investors, including those who invest for themselves only.

In recent years, an increasing number of investors are taking direct control of their personal investments. One reason for this trend is that technology advances make it easy for investors to manage their own accounts, often making it more convenient and less expensive than relying on financial intermediaries. With online investing, investors are afforded the flexibility to invest at times and in places that are convenient for them. In addition, the Internet offers instant access to research and financial information, such as real-time stock quotes, company financial information, investment advice, analysts' research, earnings estimates, and the like.

Due to these advances, individual investors have become increasingly sophisticated and knowledgeable about investing, dramatically narrowing the gap between resources available to the individual investor and the institutional investor. As investors obtain even greater access to these resources, they will desire even greater control over their financial decisions and seek alternative ways to invest more successfully.

Certain investors may invest in mutual funds and/or follow the recommendations of stock analysts and other investment advisors. At any given time, an investor typically wants to be invested in the best-performing mutual fund, stock, or other investment vehicle to maximize their return on investment. However, to be continually invested in the best-performing investment vehicles, an investor must regularly track all mutual funds, investment advisors, and other sources of investment information. When the top-performing investment vehicle changes, the individual investor must reallocate their investments to be in alignment with the new top-performing investment vehicle. This tracking of information and reallocation of investments is tedious and time-consuming.

Accordingly, there is a need for a way to allow an investor to allocate their investments among top-performing investment vehicles in an optimal (or close to optimal) manner and efficiently make adjustments to maintain their investments in the current top-performing investment vehicles.

### BRIEF DESCRIPTION OF THE DRAWINGS

FIG. 1 is an investment services architecture having an investment services hosting site that offers investment tools and services to investors via a network, such as the Internet.

FIG. 2 is a block diagram of an exemplary computer that may be used in the investment services architecture.

FIG. 3 illustrates an exemplary set of data records that maintain an investor's portfolio and the performance metric associated with the portfolio.

FIG. 4 is a flow diagram illustrating a procedure for creating an ideal investment portfolio.

FIG. 5 is a flow diagram illustrating a procedure for combining multiple investment portfolio holdings into a single ideal investment portfolio.

FIG. 6 illustrates an example of creating a merged set of holdings by averaging the holdings of two different investment portfolios.

FIG. 7 illustrates an example of creating a merged set of holdings by combining the holdings of two different investment portfolios in which the holdings of one investment portfolio are given a greater weight.

FIG. 8 illustrates an example of creating a merged set of holdings by combining selected holdings of three different investment portfolios.

FIG. 9 is a flow diagram illustrating a procedure for modifying a merged set of holdings based on changes in investment portfolios or investment portfolio holdings.

FIGS. 10A-10C illustrate a flow diagram of a procedure for generating trades in a real portfolio based on an ideal investment portfolio.

FIG. 11 is a flow diagram illustrating a second procedure for generating trades in a real portfolio based on an ideal investment portfolio.

### DETAILED DESCRIPTION

An investment services architecture provides a suite of investment management tools and services to investors via the Internet or other data communication network. The architecture includes an investment services hosting site that offers investment services to investors who access the services via the Internet using various investor computing devices. As part of the offering, the investment services hosting site allows individual investors to create and manage virtual investment portfolios that can be objectively ranked by performance. The investment services hosting site further provides tools to create ideal investment portfolios that are comprised of the holdings of two or more top-performing virtual investment portfolios. The ideal investment portfolios can then be used to control the holdings of real investment accounts or mutual funds. In one embodiment, the investment services system offers and manages performance-based investment competitions based on model investment portfolios.

Additionally, the investment services architecture allows an individual to select their own set of investment portfolios to create their own personal ideal investment portfolio. An investment portfolio may be the real or hypothetical holdings of a person (such as a professional mutual fund manager, a stock analyst, or an individual investor), a group of individuals (such as an investment club or a group of analysts) or may be a collection of investments (such as a single mutual fund or a group of mutual funds). The investment services architecture described herein is capable of merging the holdings of two or more investment portfolios into a single ideal investment portfolio that is continually changing as the set of investment portfolios changes and as the holdings selected by each investment portfolio changes.

Through these offerings, the investment services system attempts to attract and identify the best investors in a potentially huge universe of investors. Once identified, the investment services system can create and operate actual portfolios based on the trades made by these best individual investors, essentially empowering these non-professional investors as fund managers or investment portfolio sources.

To identify the best investors, the investment services system monitors the performances of all participating investors. The performance must be measured using a non-biased metric that accounts for irregular investment patterns (e.g., non-uniform deposits and withdrawals), as well as common investing events such as stock splits, dividends, mergers, acquisitions, divestiture, and the like.

The following disclosure describes a unique performance metric that is specially designed for individual investors. It is called the “investor's total account value”, or “iTAV”. It is measured on a per share basis, and can be used to monitor each investor's performance. Additionally, the investor's total account value can be the basis by which investors are compared to one another to identify the best investors in the large universe of investors. It's the metric that enables individual investors to answer the question, “How am I doing?”

Internet-Based Financial Services System

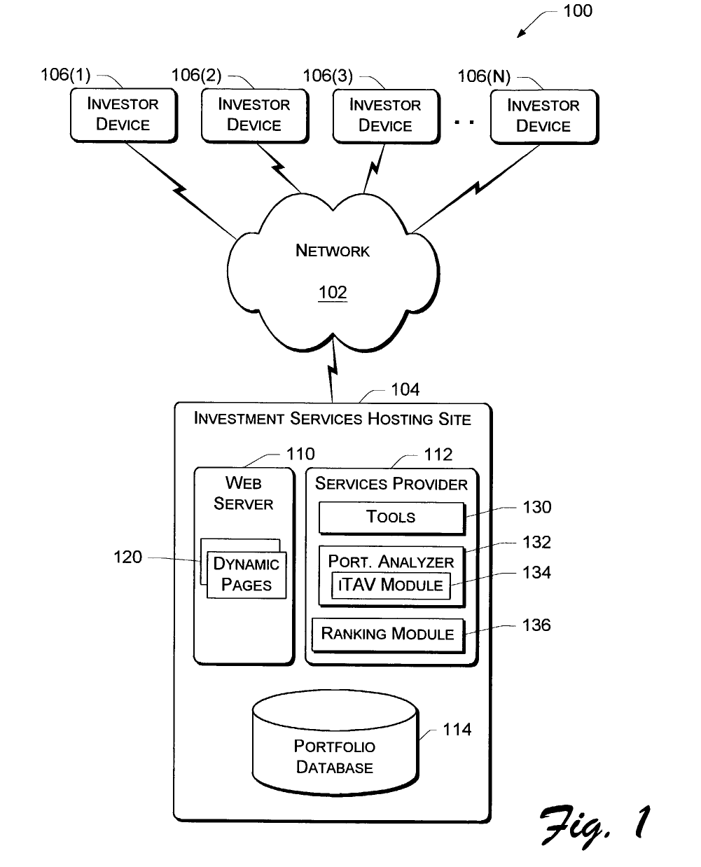

FIG. 1 shows an exemplary investment services architecture 100 that allows investors to access financial investment services via a network 102, such as the Internet. While the architecture 100 can be implemented using other networks (e.g., a wide area network) and should not be limited to the Internet, the investment services architecture 100 will be described in the context of the Internet as one suitable network architecture.

The investment services architecture 100 has an investment services hosting site 104 that forms a Web site on the Internet 102. The investment services hosting site 104 provides investment services to investors who access the services via the Internet using various types of investor devices 106(1), 106(2), 106(3), . . . , 106(N).

The investment services hosting site 104 has a Web server 110, a services provider 112, and an investor portfolio database 114. The Web server 110 handles multiple requests from the investor devices 106(1)-106(N) and serves Web pages 120 containing financial and investment information to the requesting investors. The Web server 110 may be implemented as one or more computers that are configured with server software to host a site on the Internet 102.

The Web server 110 implements dynamic server technologies that generate and serve dynamic Web pages 120 tailored to individual investors. Unlike static Web pages that are pre-constructed and served from storage, dynamic Web pages are generated on-the-fly in response to individual requests from investor devices 106. In this manner, the Web server 110 can craft pages using investor-specific information obtained from the request, the services provider 112, and/or the portfolio database 114.

It is noted that the investment services hosting site 104 may be configured to transmit information in data formats other than HTML (hypertext markup language) pages. As one example, the site 104 may be configured with a transmitter (not shown) to transmit information to wireless investor devices with limited screen sizes. Thus, the Web pages are merely shown for explanatory purposes, as other data formats and transmission protocols may be used.

The services provider 112 is a backend computing system comprised of one or more computers that are configured to support the investment-related computing tasks. For a passive visitor to the Web site, the services provider 112 may offer introductory information on investing, as well as general advice and market data. The mix of services is designed to attract the passive visitor and convert him/her to an active participant at the site.

For active participants, the services provider 112 allows investors to create and manage portfolios, which are kept in portfolio database 114. The portfolios may be real portfolios that reflect investors' true holdings, or virtual portfolios that do not correlate to invested money but are used for tracking stocks or for competition purposes. Further, the portfolios may include one or more ideal investment portfolios that are created by merging two or more sets of holdings.

The service provider 112 offers a set of tools 130 to assist the investors in analyzing their portfolios and individual investment opportunities, such as stocks or bonds. As examples, the tools 130 might include portfolio-centric tools for identifying outperforming and underperforming investments in a portfolio and determining the volatility of an investor's portfolio over various time periods (e.g., 3 months, 6 months, 9 months, 12 months, and 24 months). The tools 130 may further include investment-centric tools such as market timing analysis that examines how well specific purchases and sales of individual investments have played out over time, sales and earnings growth analysis for individual equities, and risk-adjusted return analysis. The tools 130 may also allow a user to select mutual funds or sets of holdings to be merged into a single ideal investment portfolio.

The services provider 112 includes a portfolio analyzer 132 that maintains investor portfolios and tracks their performance. The portfolio analyzer 132 monitors account activities—trades, withdrawals, deposits, dividends, stock splits, etc.—and updates the portfolios in the portfolio database accordingly. The portfolio analyzer 132 receives investment and market information from one or more various market sources (not shown) to maintain current up-to-date information. The portfolio analyzer 132 may also be configured to download actual portfolio data from brokerages that perform the actual trading for the investors.

The portfolio analyzer 132 has an iTAV module 134 that computes the investor's total account value. In particular, the iTAV module 134 computes the following:

iTAV=Current Value of Investor's Account/Number of Portfolio Shares

The number of shares in the denominator is initially an arbitrary number assigned to the account. The number of shares is modified upon certain events that affect the account but not investor performance, such as cash withdrawals, cash deposits, and the like.

As a simple example, suppose the current value of the investor's account is $25,000 and that the investor had 10,000 shares. This would yield an iTAV of $2.5/share (i.e., 25,000/10,000=2.5). Next, suppose that over time the total value of the investor's account increased to $30,000. The new iTAV would be $3/share (i.e., 30,000/10,000=3.0). Performance over this time frame can be determined as the percentage gain from $2.5/share to $3/share, or a 20% gain.

The investor's total account value is an objective, reliable measure of how well an individual's personal portfolio is performing over time, as well as in comparison to the market, other investors, or other benchmarks. Total account value enables investors to measure and compare the success of their ideas as investments.

The portfolio analyzer 132 stores an iTAV for each investor in the investor portfolio database 114 in association with the investor. The portfolio analyzer 132 updates this metric periodically, such as once per day or more frequently.

The services provider 112 may further include a ranking module 136 that ranks individual investors based on their iTAV. The ranking module 136 occasionally sorts data records kept in the investor portfolio database 114 to identify those investors who are outperforming their peers. The ranking process may be executed over the entire universe of investors, or segmented according to investment strategies (e.g., value, growth, etc.), sectors (e.g., technology, biotechnology, cyclicals, drugs, etc.), equity types (e.g., small cap, mid-cap, large cap), clubs, teams, leagues, geographic locations (e.g., all investors in Nebraska), age groups, gender, and the like.

Exemplary Computer

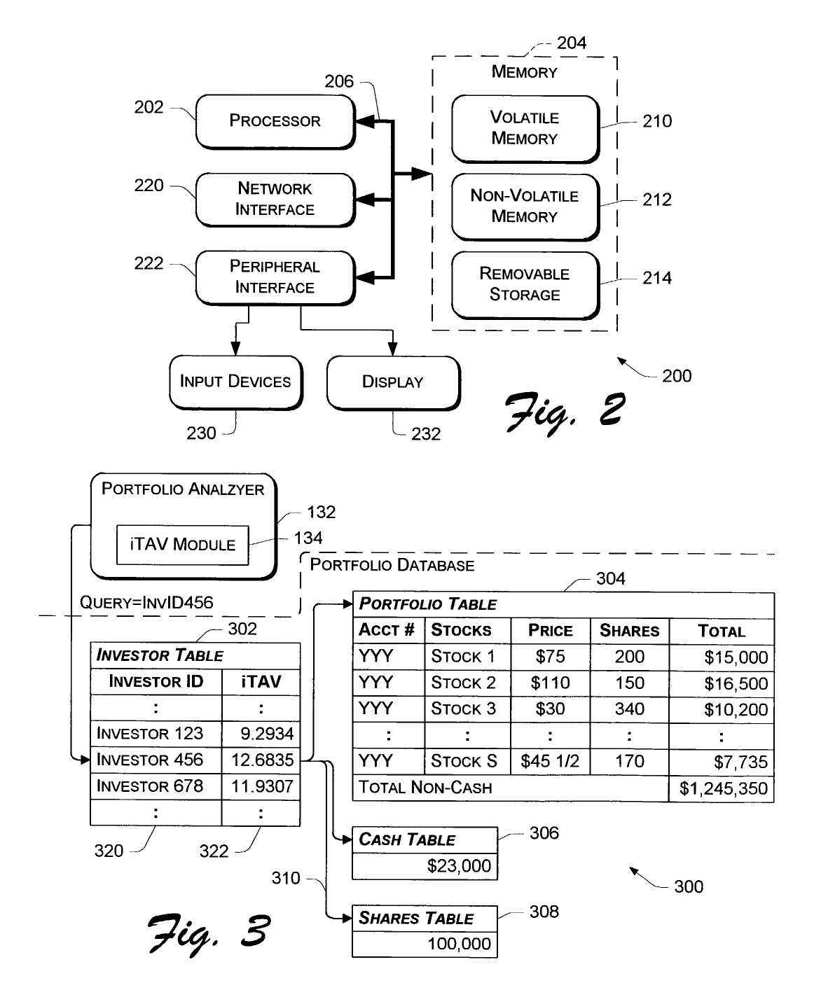

FIG. 2 shows an exemplary computing device 200 that may be used to implement an investor device 102 or one or more computers at the investment services hosting site. The computer system 200 can be configured, for example, as a server computer, a database computer, an investor computing device, or a computing device that implements the network. The computer system 200 can be used to host investment services functions such as serving or rendering a web page containing information regarding investment services, enabling investors to establish and manage portfolios, monitoring performance of the investors account, and ranking investors to identify the best investors.

Computer 200 includes at least one processor 202 and memory 204 coupled to a bus 206. Bus 206 represents one or more of many different bus structures, such as a memory bus or memory controller, a peripheral bus, and a processor or local bus using any of a variety of bus architectures and protocols. Memory 204 might include volatile memory 210 (e.g., RAM) and non-volatile memory 212 (e.g., ROM, Flash, hard disk, RAID system, etc.) to provide for non-volatile storage of data (e.g., computer-readable instructions, data structures, program modules and other data used by computer 200). Memory 204 might further include a removable storage device 214 to accommodate removable storage media (e.g., floppy disk, PCMCIA cards, tape, CD-ROM, etc.). It will be appreciated that other types of computer-readable media which can store data that is accessible by a computer, such as flash memory cards, digital video disks, and the like, may also be used in the exemplary computer.

A network interface 220 is coupled to bus 206 to provide an interface to a data communication network, such as a local area network (LAN), a wide area network (WAN), or the Internet, for exchanging data with other computers and devices.

A peripheral interface 222 is coupled to bus 206 to provide an interface for individual peripheral devices. Exemplary peripheral devices include one or more input devices 230 (e.g., keyboard, keypad, touch pad, mouse, trackball, microphone, joystick, video camera, etc.) and a display 232 (e.g., monitor, LCD, TV, etc.). Other possible peripheral devices, which are not depicted, include a network interface (e.g., modem, satellite receiver, RF transceiver, network card, etc.) and one or more non-display output device(s) (e.g., printer, speakers, scanner, etc.).

A variety of program modules can be stored in memory 204, including an operating system, a server system, one or more application programs (e.g., portfolio analysis program), and other program modules and program data. In a networked environment, some or all of the program modules executed by computer 200 may be retrieved from another computing device coupled to the network.

Typically, the computer 200 is programmed using instructions stored at different times in the various computer-readable media of the computer. Programs and operating systems are often distributed, for example, on floppy disks or CD-ROMs. The programs are installed from the distribution media into a storage device within the computer 200. When a program is executed, the program is at least partially loaded into the computer's primary electronic memory. These and other types of computer-readable media contain instructions or programs for implementing the group buying processes described below.

Computer system 200 is exemplary only—additional components may be included in system 200 and/or some components may not be included in system 200. By way of example, system 200 may include co-processors that operate in conjunction with processor 202. By way of another example, a wireless computing device may include a wireless transceiver, but not include removable storage 214.

iTAV Data Records

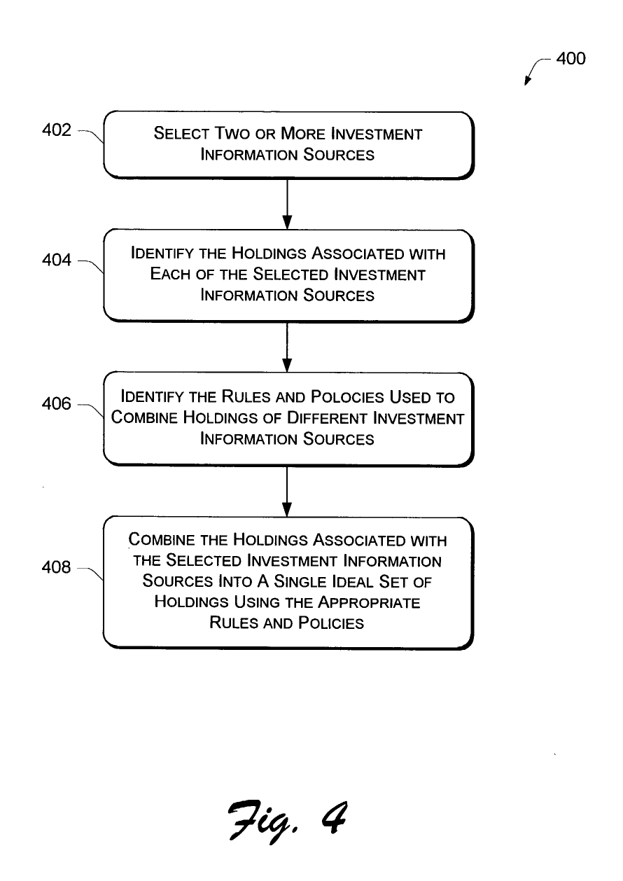

FIG. 3 shows one exemplary set of investor data records 300 that may be used to store iTAV metric in association with each investor and update the iTAV metric as needed. In this example, the database is configured as a relational database in which data records are organized in tables that may be associated with one another using definable relationships.

In the illustrated implementation, the investor data is organized in an investor table 302, a portfolio table 304, a cash table 306, and a portfolio shares table 308. The investor table 302 maintains an investor ID field 320 to hold identification information of each individual investor (e.g., name, address, email, phone, account numbers, etc.) and an iTAV field 322 to hold the investor's associated iTAV metric. Data records in the investor table 302 are correlated with corresponding records in portfolio table 304, cash table 306, and portfolio shares table 308 via relationships, such as those relationships illustrated as lines 310 linking records for “Investor 456” with other records.

The portfolio table 304 lists one or more investments of the investor in a real or virtual portfolio account. The portfolio table 304 might includes stocks, bonds, options, and other investment vehicles. In this example, the portfolio table 304 contains an account ID field to hold the portfolio account ID, a stock field to hold identities of individual stocks, a current price field to list the price of the stock, a share field to hold the number of shares owned of each stock, and current value for each individual stock holding. The portfolio table 304 also holds a total value of all non-cash investments (e.g., $1,245,350).

The cash table 306 maintains any cash balance for the investor. Here, the investor currently holds $23,000 in cash.

The portfolio shares table 308 holds the number of portfolio shares currently associated with an investors account. Initially, each account is assigned an arbitrary number of shares. For a virtual portfolio with an original total value of $1,000,000, the portfolio analyzer might assign 100,000 shares to establish an initial iTAV of $10/share. Over time, the number of shares can change to keep the iTAV constant upon occurrence of certain events, such as cash withdrawals, cash deposits, and the like that don't affect investor performance.

The portfolio analyzer 132 resides on the services provider 112 (FIG. 1) and makes queries to the portfolio database 114. Suppose the portfolio analyzer is interested in investor 456, as indicated by the query for “InvID456”. The queried record indicates that the investor has an investor total account value of $12.6835/share.

The iTAV module 134 derives this metric by adding the total non-cash value from portfolio table 304 (i.e., $1,245,350) and the cash value from cash table 306 (i.e., $23,000) to yield $1,268,350 and dividing that value by the number of portfolio shares obtained from shares table 308 (i.e., 100,000) to produce $12.6835/share. Each time the iTAV is computed, it is stored in the investor table 302 to keep the metric current.

Ideal Investment Portfolios

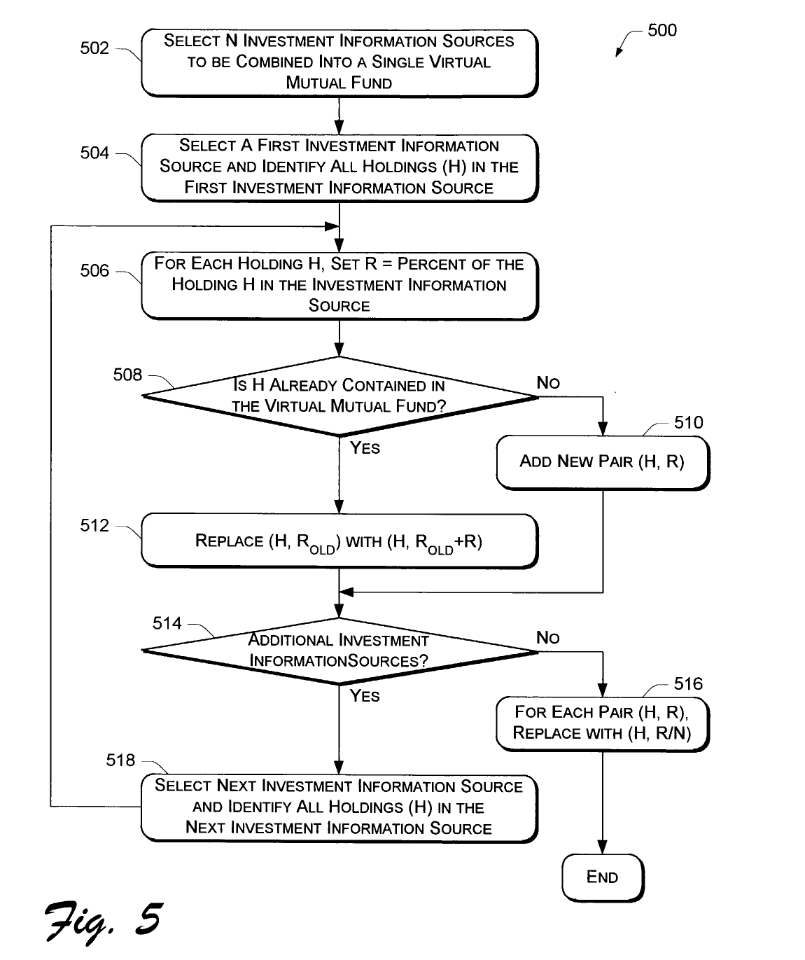

FIG. 4 is a flow diagram illustrating a procedure 400 for creating an ideal investment portfolio. An ideal investment portfolio may also be referred to as an ideal set of holdings or a merged set of holdings. The procedure 400 may be implemented by the investment services hosting site 104, and particularly the services provider 112 and portfolio database 114. The procedure 400 may be implemented in software as computer executable instructions that, when executed, perform the operations illustrated as blocks in FIG. 4.

The procedure 400 begins by selecting two or more investment portfolios (block 402). An “investment portfolio” is a set of holdings that may include any number of stocks, bonds, mutual funds, precious metals, investible securities, etc. Investment portfolios may be associated with a person (such as a professional mutual fund manager, a stock analyst, or an individual investor), a group of individuals (such as an investment club or a group of analysts) or may be any collection of investments (such as a single mutual fund or a group of mutual funds). For example, one investment portfolio may be the holdings of a top-performing mutual fund and another investment portfolio may be the holdings of an otherwise unknown, but top-performing individual investor. The selected investment portfolios may be top-performers in a particular market sector (such as technology, health care, or transportation), a particular investment style (such as aggressive, moderately aggressive, conservative, value, or growth), or in a particular type of investment (such as stocks, bonds, or precious metals).

The selection of investment portfolios can be based on, for example, the portfolio's performance by period (e.g., month, quarter or year), the portfolio's fund sector (e.g., communications or biotech), the portfolio's fund style, the portfolio's similarity to an individual's own positions, the portfolio's momentum (e.g., is the fund moving into biotech), postings by the portfolio manager on one or more investment forums, which stocks the portfolio has been buying or selling, the personal preferences of the investor making the selection, or any other parameter that might be of interest to an investor.

After selecting two or more investment portfolios, the procedure 400 identifies the holdings associated with each of the selected investment portfolios (block 404). In the case of a mutual fund, the holdings associated with the mutual fund are the current stocks, bonds, and other equities currently owned by the mutual fund. When identifying the holdings of each selected investment portfolio, the procedure also determines the percentage of the total holdings represented by each individual holding. For example, a mutual fund may own Stock A which represents ten percent of the total value of the mutual fund, Stock B which represents eight percent of the total value of the mutual fund, and Stock C which represents fourteen percent of the total value of the mutual fund.

When the investment portfolio is an ideal investment portfolio associated with an individual person rather than a mutual fund, the holdings associated with the investment portfolio are the holdings contained in the model portfolio or an actual portfolio maintained or recommended by the individual, including stocks, bonds, mutual funds, options, futures or any other investible securities. If the investment portfolio's holdings are recommendations without any weighting or portfolio percentage applied to each individual holding, then all holdings may be assigned the same percentage.

After identifying the holdings associated with each of the selected investment portfolios, the procedure 400 identifies the rules and policies used to combine holdings of the different investment portfolios (block 406). These rules and policies may be generalized for multiple users or may be set to the preferences of a particular user. The rules and policies determine, for example, which investment portfolio's holdings to include in the ideal set of holdings and how much of that holding (e.g., how many shares or what percent of the total value of the ideal set of holdings) to include in the ideal set of holdings. These rules and policies are discussed in greater detail below.

In block 408 of FIG. 4, the holdings associated with the selected investment portfolios are combined into a single ideal set of holdings using the appropriate rules and policies previously identified in block 406. Thus, the ideal set of holdings represents the combination of the best investment knowledge of all the investment portfolios and, in many cases, may perform better than the holdings of any of the individual investment portfolios. The procedure 400 continues to monitor the selected portfolios for changes and will update the ideal investment portfolio accordingly (block 410). Additional details regarding the entering of changes in the ideal investment portfolio are provided below.

When combining the holdings of two or more investment portfolios into a single ideal investment portfolio, the particular rules and policies followed will affect the holdings of the ideal investment portfolio. For example, if the holdings of two investment portfolios are averaged together, then each holding is given an equal weight. In this example, all holdings of each investment portfolio are represented in the ideal investment portfolio. In other embodiments, only a portion of one or both investment portfolio holdings are selected for the combined ideal investment portfolio. Further, the rules and policies may assign different weightings to different investment portfolios and/or to different holdings of the investment portfolios. For example, if the quality and duration of the past performance of one investment portfolio is better than the other investment portfolio, that investment portfolio's holdings are assigned a higher weighting. For instance, if a particular investment portfolio has a higher annualized return than the other investment portfolios or has a longer track record with that return, that particular investment portfolio's holdings should have a greater influence on the composition of the ideal investment portfolio.

Other rules and policies may consider the momentum of each of the holdings of the investment portfolios. For example, if an investment portfolio recently purchased additional shares of a particular stock, that stock has positive momentum and should contribute to a larger position in the ideal investment portfolio. Similarly, if an investment portfolio recently sold shares of a particular stock, that stock has negative momentum and the remaining shares of that stock should contribute less to the composition of the ideal investment portfolio.

Another set of rules and policies may limit the total number of stocks contained in the ideal investment portfolio. For example, if the holdings of three different investment portfolios are being merged and each investment portfolio's holdings contain 20 different stocks, the ideal investment portfolio may not contain 60 different stocks. Instead, the ideal investment portfolio may be composed of the “best” stocks from each investment portfolio's holdings. The resulting ideal investment portfolio may include, for example, 21 stocks (i.e., the top seven stocks from each investment portfolio's holdings). Stocks may also be selected based on those representing at least a particular portion of the portfolio (e.g., 5%), those held for at least three months, those with a share value greater than x dollars, those in a particular sector, those having at least a minimum market capitalization value, or other parameters useful for differentiating stocks or other investments from one another.

Other rules and policies may take advantage of similar holdings in the funds being combined. For example, if all three of the sets of holdings being combined include a particular stock, that may be considered broad support for that stock, resulting in a larger position in the ideal investment portfolio. Similarly, if the holdings of several investment portfolios are being combined and a particular stock is found in the holdings of only one investment portfolio, that may be considered weak support for that stock, resulting in a smaller position (or no position) in the ideal investment portfolio.

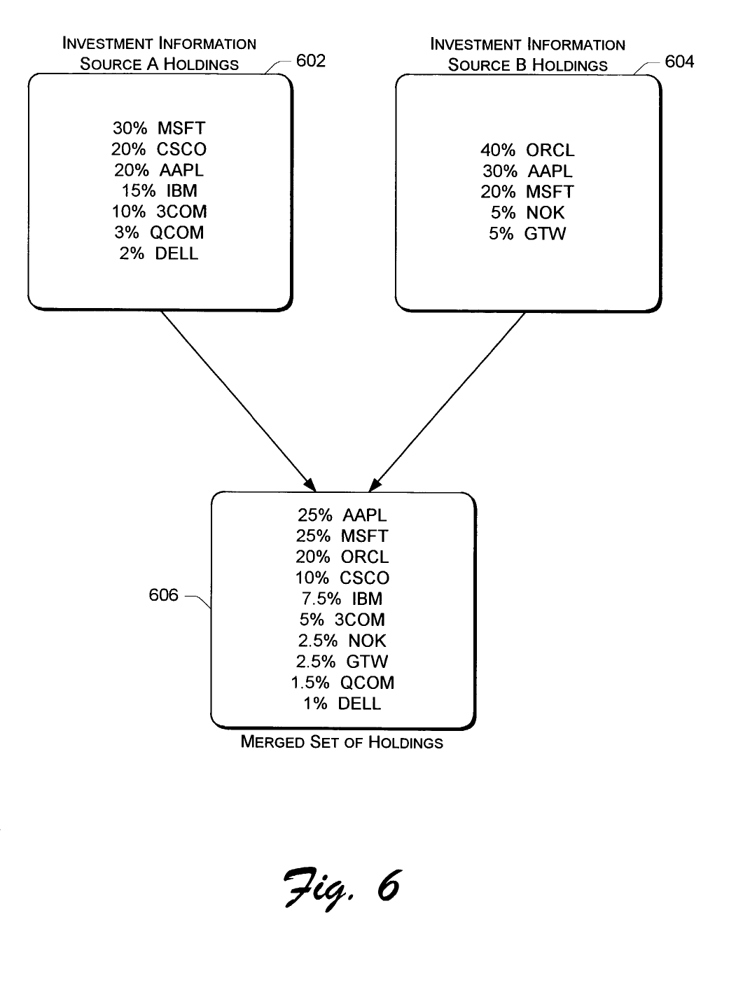

FIG. 5 is a flow diagram illustrating a procedure 500 for combining multiple investment portfolio holdings into a single ideal investment portfolio. Initially, N different investment portfolios are selected to be combined into a single ideal investment portfolio (block 502). At block 504 of FIG. 5, the procedure 500 selects a first investment portfolio and identifies all holdings (H) in the first investment portfolio. For each holding (H), an associated value (R) is set to the percentage of the holding in the investment portfolio (block 506). For example if a particular holding represents 5% of the total value of all holdings in the investment portfolio, then the associated R=0.05.

Next, the procedure 500 determines whether each holding H is already contained in the ideal investment portfolio (block 508). If a particular holding is not already contained in the ideal investment portfolio, then a new data pair (H, R) is created, where R is the percentage value associated with the holding H (block 510). If a particular holding is already contained in the ideal investment portfolio, then the previous value of (H, R_{old}) is replaced with (H, R_{old}+R), thereby adding the R value associated with the holding's percentage in the current investment portfolio to the previous R value, which is associated with the same holding's percentage in other investment portfolios (block 512). The steps represented by blocks 506-512 are performed for each holding in the investment portfolio.

At block 514, the procedure 500 determines whether there are additional investment portfolios to be merged into the ideal investment portfolio. If no additional investment portfolios remain, each data pair (H, R) is replaced with (H, R/N) to adjust the holding's percentage based on the number of investment portfolios N (block 516). If additional investment portfolios remain to be merged into the ideal investment portfolio, the procedure selects the next investment portfolio and identifies all holdings H in the next investment portfolio (block 518). The procedure 500 then returns to block 506 to process the holdings of the next investment portfolio. The resulting data pairs (H, R) represents the list of holdings and their relative percent of the ideal investment portfolio. In this example, the various holdings are averaged together in the ideal investment portfolio. Alternatively, the holdings may be merged together using any one or more of the polices and/or rules discussed herein. For example, only holdings representing at least 1% of their respective investment portfolio may be considered for merging into the ideal investment portfolio.

In a particular embodiment, the default technique for determining the percentages of holdings in the ideal investment portfolio is to average the holdings together (e.g., using the procedure discussed above with respect to FIG. 5). If particular holdings are not merged into the ideal investment portfolio, the percentage of excluded holdings is redistributed among the holdings that are included in the ideal investment portfolio. For example, if x% of the holdings of an investment portfolio are excluded, then for each included holding, that holding's percentage is adjusted as follows to distribute the excluded holdings percentages across all included holdings:

$$\text{New percentage of holding} = 1 + \frac{x}{100 - x}$$

For example, consider the following holdings of an investment portfolio:

| | |
|---|---|
| 40% | Oracle |
| 20% | Cisco |
| 20% | Apple |
| 10% | Microsoft |
| 5% | Hewlett-Packard |
| 5% | Dell |

In this example, all holdings less than 10% (i.e., Hewlett-Packard and Dell) are excluded from the ideal investment portfolio. The two ignored holdings represent 10% of the total holdings. Using the above equation:

$$\text{New percentage of holding} = 1 + \frac{10}{100 - 10} = 1.111$$

Thus, the percentage of each included holding is multiplied by 1.111 to determine the percentage of that holding to include in the ideal investment portfolio. In the above example, the modified holding percentages are:

| | |
|---|---|
| 44.444% | Oracle |
| 22.222% | Cisco |
| 22.222% | Apple |
| 11.111% | Microsoft |
| 0% | Hewlett-Packard |
| 0% | Dell |

These percentages are combined with percentages of other investment portfolios to generate a ideal investment portfolio. Note that the holdings of different investment portfolios may be handled differently before merging some or all of those holdings into a ideal investment portfolio. For example, the holdings of one investment portfolio may be averaged into the ideal investment portfolio using a procedure similar to the procedure discussed above with respect to FIG. 5. For another investment portfolio, only the holdings that are greater than 5% are averaged into the ideal investment portfolio. When processing another investment portfolio, the process may exclude holdings that have been added to the investment portfolio within the last five days. Thus, different filtering or processing techniques can be applied to the holdings of different investment portfolios when merging various holdings into a ideal investment portfolio.

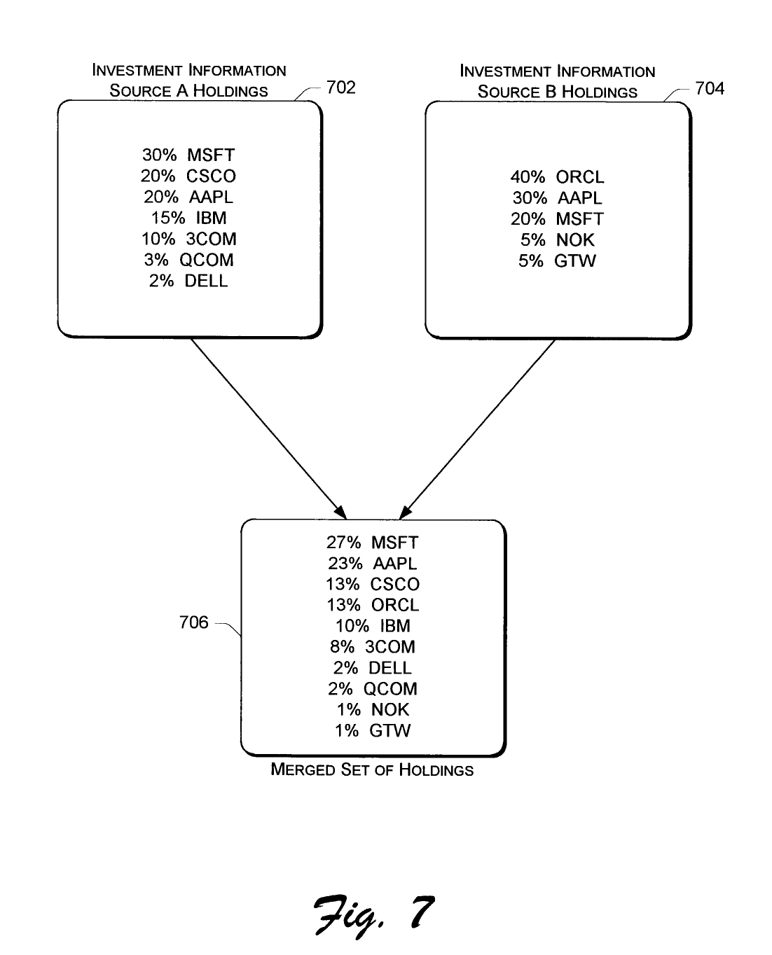

FIG. 6 illustrates an example of creating a merged set of holdings by averaging the holdings of two different investment portfolios. A first investment portfolio (Investment Portfolio A) has an associated set of holdings 602, which include seven different stocks. The number next to each stock symbol is the percentage of the total value of the holdings represented by the stock. For example, Microsoft (symbol MSFT) represents 30% of the total value of the Investment Portfolio A holdings 602 and Cisco (symbol CSCO) represents 20% of the total value of the Investment Portfolio A holdings. A second investment portfolio (Investment Portfolio B) has an associated set of holdings 604, which include five different stocks. Two of the five stocks (AAPL and MSFT) in the Investment Portfolio B holdings 604 are also contained in the Investment Portfolio A holdings 602.

The two sets of holdings 602 and 604 are averaged together to form a merged set of holdings 606. The merged set of holdings 606 includes ten different stocks. The holdings are averaged such that the merged set of holdings 606 contains an equal mix of both investment portfolio holdings 602 and 604. When merging a stock that is contained in both investment portfolio holdings 602 and 604, the percentages of the stock in the two advisor holdings are added together and divided by two to average the weighting of the stock. For example, MSFT represents 30% in holdings 602 and 20% in holdings 604, resulting in an average of 25%. When merging a stock that is contained in only one investment portfolio holding 602 or 604, the percentage of the stock is divided by two to determine the percentage of the stock in the merged set of holdings 606. For example, ORCL represents 40% in holdings 604, but is not contained in holdings 602. Thus, ORCL represents 20% of the total value of the merged set of holdings 606.

FIG. 7 illustrates an example of creating a merged set of holdings by combining the holdings of two different investment portfolios in which the holdings of one investment portfolio are given a greater weight. A first investment portfolio (Investment Portfolio A) has an associated set of holdings 702, which include seven different stocks. The number next to each stock symbol is the percentage of the total value of the holdings represented by the stock. A second investment portfolio (Investment Portfolio B) has an associated set of holdings 704, which include five different stocks. Two of the five stocks (AAPL and MSFT) in the Investment Portfolio B holdings 704 are also contained in the Investment Portfolio A holdings 702. The two sets of holdings 702 and 704 are combined together to form a merged set of holdings 706. The merged set of holdings 706 includes ten different stocks.

In this example, the Investment Portfolio A holdings 702 have a significantly better rate of return and/or a longer track record than the Investment Portfolio B holdings 704. Thus, when combining the two sets of holdings 702 and 704, the Investment Portfolio A holdings 702 are given a larger position in the merged set of holdings 706. For example, when combining the two MSFT stock holdings (30% in Investment Portfolio A holdings and 20% in Investment Portfolio B holdings), the combined stock in the merged set of holdings is closer to 30% than 20%. In this example, the combined MSFT stock is 27% of the total value of the merged set of holdings 706. In another example, ORCL represents 40% of the Investment Portfolio B holdings 704, but only represents 13% of the merged set of holdings 706. This significant reduction in the representation of ORCL reflects the smaller position that the Investment Portfolio B holdings represent in the merged set of holdings.

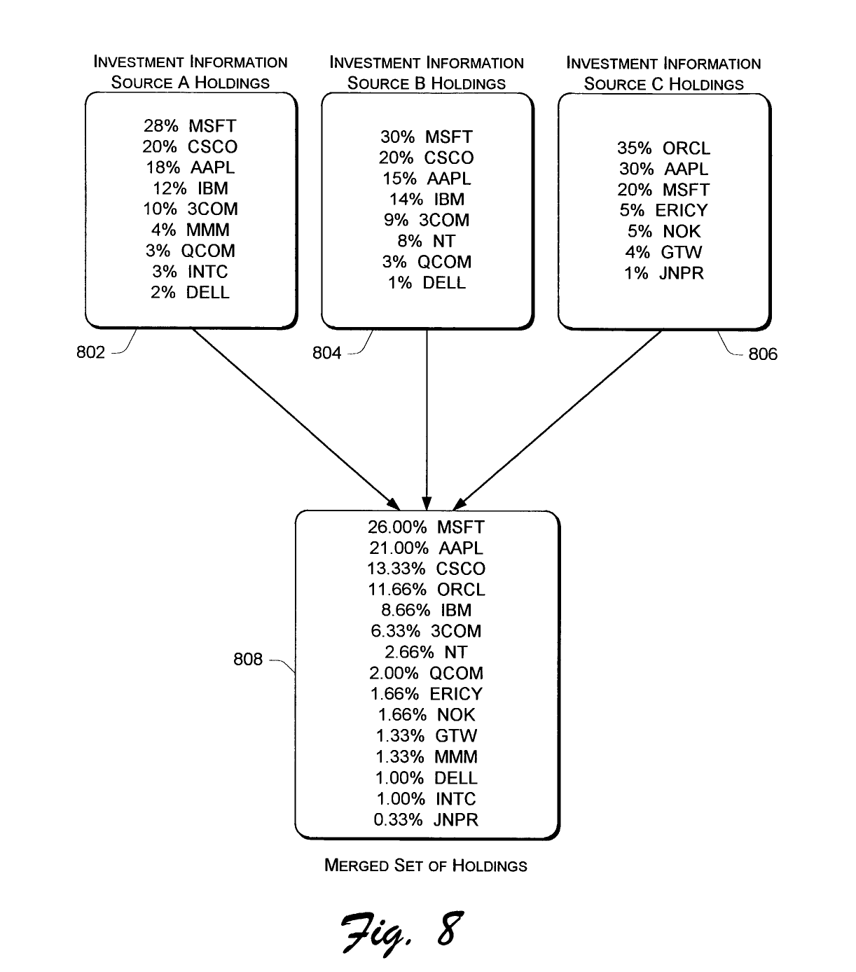

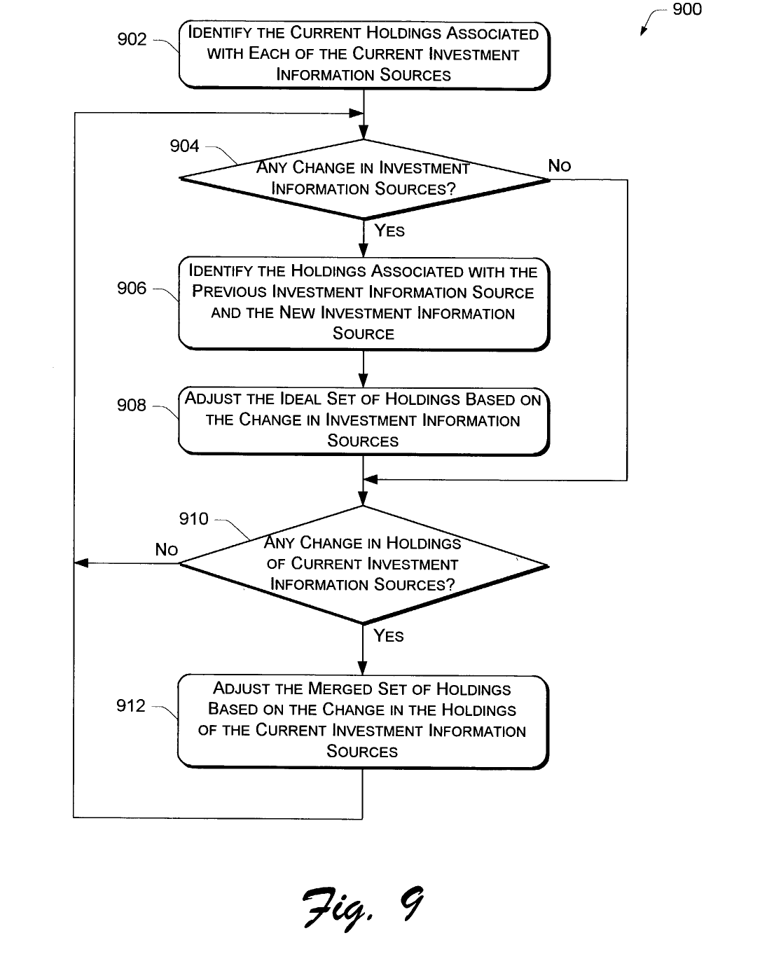

FIG. 8 illustrates an example of creating a merged set of holdings by combining selected holdings of three different investment portfolios. A first investment portfolio (Investment Portfolio A) has an associated set of holdings 802, which include nine different stocks. The number next to each stock symbol is the percentage of the total value of the holdings represented by the stock. A second investment portfolio (Investment Portfolio B) has an associated set of holdings 804, which include eight different stocks. A third investment portfolio (Investment Portfolio C) has an associated set of holdings 806, which include seven different stocks. Two stocks (AAPL and MSFT) are represented in all three holdings 802, 804, and 806. The three sets of holdings 802, 804, and 806 are combined together to form a merged set of holdings 808. In this example, all stocks contained in one or more of the holdings 802, 804, and 806 are included in the merged set of holdings 808. The holdings of the merged set are determined by averaging the percentages of stocks in the three holdings 802, 804, and 806. For example, stock symbol AAPL has a total of 63% (18%+15%+30%). Dividing 63% by three yields 21%, which is the percentage of AAPL stock represented in the merged set of holdings 808. The averaging process divides by three because three different sets of holdings 802-806 are being merged together.

In other embodiments, certain stocks contained in one or more of the holdings 802, 804, and 806 are excluded from the merged set of holdings 808. Certain stocks may be excluded, for example, because they represented a very small percentage of the total holdings, were recently added to the set of holdings, or a portion of the stock has recently been sold.

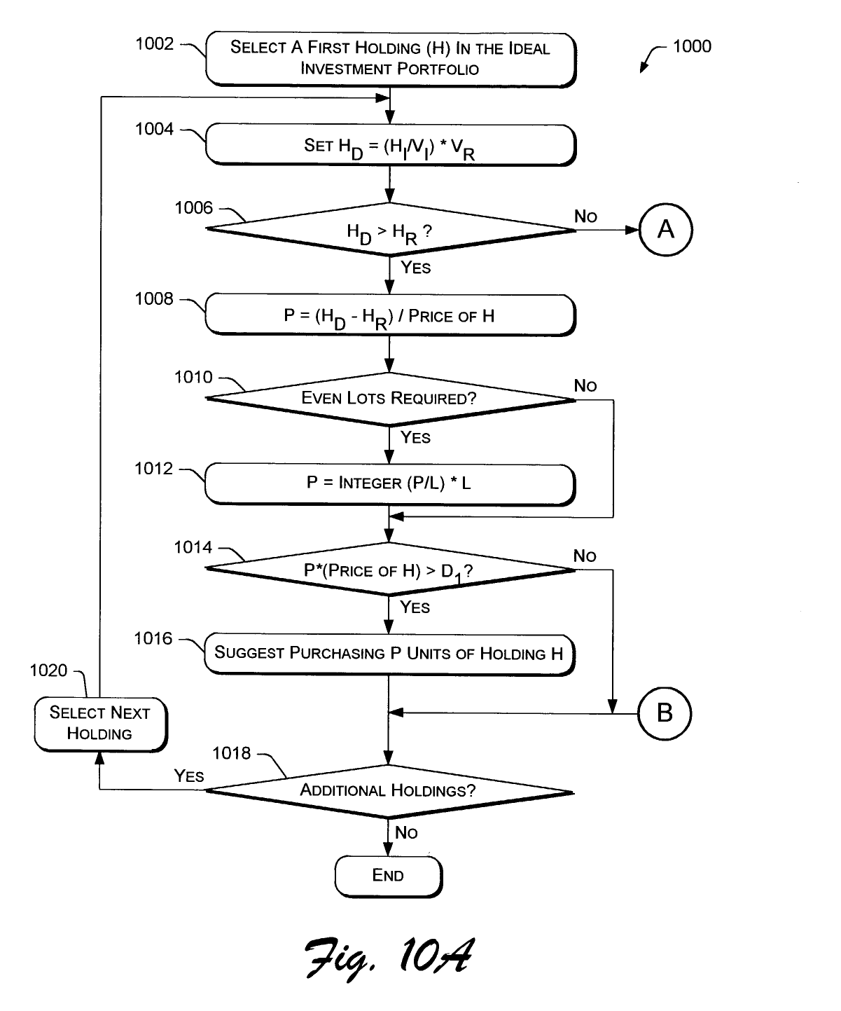

FIG. 9 is a flow diagram illustrating a procedure 900 for modifying a merged set of holdings based on changes in investment portfolios or investment portfolio holdings. At block 902, the procedure 900 identifies the current holdings associated with each of the current investment portfolios (i.e., the investment portfolios whose holdings are currently included in the merged set of holdings). The procedure then determines whether there has been any change in investment portfolios (block 904). For example, if one of the investment portfolios was initially selected because the investment portfolio was the top-performing mutual fund in a particular sector for the previous two quarters, a different investment portfolio may become the top-performing mutual fund in the future. In this situation, if the top-performing mutual fund changes, then the merged set of holdings must be updated to remove holdings associated with the previous investment portfolio and add holdings associated with the new investment portfolio.

At block 906, the procedure 900 identifies the holdings associated with the previous investment portfolio and the holdings associated with the new investment portfolio. The merged set of holdings is adjusted based on the different holdings associated with the new investment portfolio (block 908). These adjustments are performed using the rules and policies discussed above. The adjustments may require the sale or purchase of one or more holdings depending on the differences in holdings between the previous investment portfolio and the new investment portfolio.

The procedure 900 then determines whether there has been any change in the holdings of the current investment portfolios (block 910). For example, a particular mutual fund may buy or sell stocks, or a stock analyst may change their list of recommended stocks. If there have been no changes in the holdings of the current investment portfolios, then the procedure returns to block 904 to test for changes in investment portfolios. If there have been changes in the holdings of the current investment portfolios, then the procedure continues to block 912, where the merged set of holdings is adjusted based on the change in the holdings of the current investment portfolios. The adjustments to the merged set of holdings are performed using the rules and policies discussed above. These adjustments may require the purchase or sale of one or more holdings depending on the changes in holdings of the current investment portfolios.

The procedure 900 discussed above automatically adjusts the holdings in the ideal set of holdings each time an investment portfolio changes or each time a change occurs in the holdings of one of the current investment portfolios. In an alternate embodiment, the user that established the merged set of holdings is first notified of the change in investment portfolio or change in investment portfolio's holdings. The user is then given an opportunity to accept or reject making the necessary changes to the merged set of holdings. If the user rejects the proposed changes, then the user may select a different investment portfolio or modify the rules and policies to cause a different adjustment in the merged set of holdings.

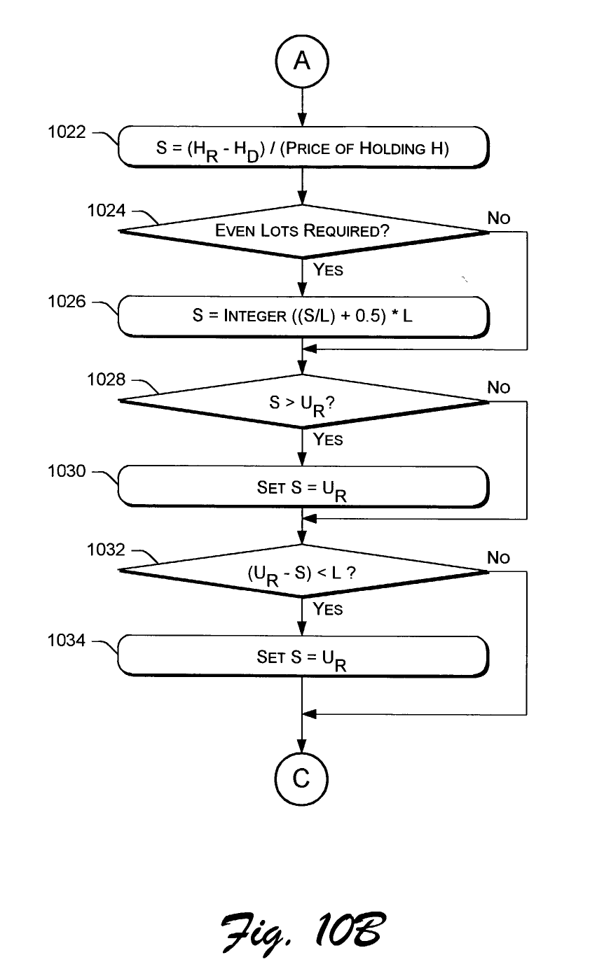

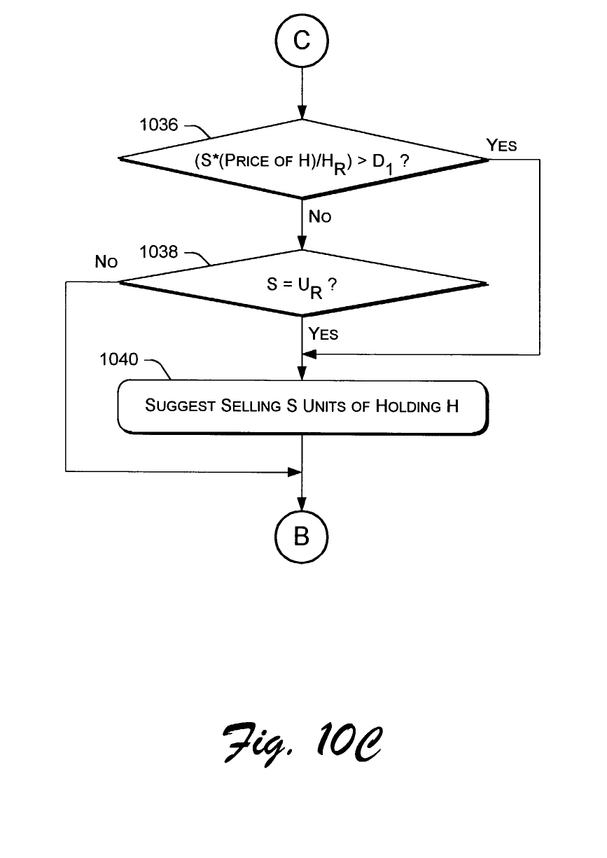

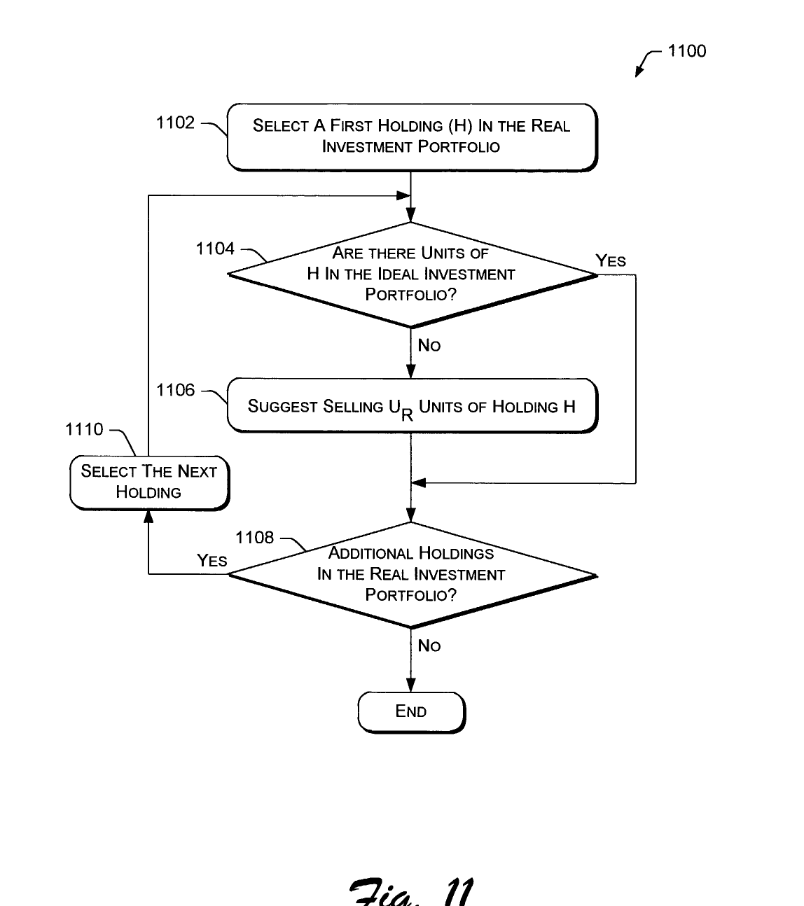

FIGS. 10A-10C illustrate a flow diagram of a procedure 1000 for generating trades in a real portfolio based on an ideal investment portfolio. After identifying or creating an ideal investment portfolio, it can be used to generate suggested trades for a real investment portfolio. The real investment portfolio represents an actual portfolio of securities. The real investment portfolio may be created and maintained by an organization (such as a financial services company or a mutual fund company), an individual, or another entity. The following variables are discussed below with respect to procedure 1000.

V_{I}=the total value of the ideal investment portfolio

V_{R}=the total value of the real investment portfolio

H_{I}=the current value of holding H in the ideal investment portfolio

H_{R}=the current value of holding H in the real investment portfolio

U_{R}=the number of units of holding H in the real investment portfolio

Initially, procedure 1000 selects a first holding (H) in the ideal investment portfolio (block 1002). A variable H_{D} represents the desired value of holding H in the real investment portfolio. In block 1004, procedure 1000 sets H_{D}=(H_{I}/V_{I})*V_{R}. This sets the desired value of holding H (H_{D}) proportional to the value of the holding in the ideal investment portfolio. Next, the procedure determines whether H_{D} is greater than H_{R} (block 1006). If H_{D} is not greater than H_{R}, the procedure branches to block 1022 in FIG. 10B. If H_{D} is greater than H_{R}, the procedure sets a variable P=(H_{D}−H_{R})/(price of H). The variable P represents the number of units of holding H to purchase.

Procedure 1000 then determines whether even lot size (e.g., whole units) transactions are required (block 1010). If so, the value of P is adjusted to the nearest even lot size. A variable L represents the lot size increments (e.g., a single unit or 100 units). At block 1012, the value of P is adjusted to P=Integer (P/L)*L. The “Integer” function truncates the value in the parenthesis down to the nearest integer. This operation of truncating reduces the risk of depleting the cash in the real investment portfolio by purchasing too many units.

To reduce transaction costs for the real investment portfolio, it may be desirable to avoid executing transactions that will not have a significant effect on the holdings of the real investment portfolio. For example, for existing holdings in the real investment portfolio, the procedure might suggest purchases if the purchase will increase the holding by at least a minimum percentage D₁. Procedure 1000 implements this restriction. Alternate embodiments of procedure 1000 may suggest all purchases regardless of the size of the purchase.

In a particular embodiment, if holding H was not previously in the real investment portfolio, the procedure requires that the holding represent at least a minimum portion of the total portfolio (D₂) before suggesting a purchase of the holding. For example, the procedure may determine if ((P*price of H)/V_{R})>D₂ before suggesting purchase of the holding.

The procedure 1000 continues at block 1014, which determines whether P*(price of H) is greater than D₁. If so, the procedure suggests purchasing P units of holding H in the real investment portfolio (block 1016). The procedure then continues to block 1018 to determine whether additional holdings remain to be considered in the ideal investment portfolio. If additional holdings remain, the procedure branches to block 1020 to select the next holding (H) and returns to block 1004 to evaluate that holding. If no additional holdings remain, the procedure ends. In a particular embodiment, the procedure 1000 is executed at periodic intervals (such as daily, weekly, or monthly).

FIG. 10B illustrates the “No” branch from block 1006 of FIG. 10A. If H_{D} is not greater than H_{R}, then it may be appropriate to sell some units of H in the real investment portfolio. A variable S represents the number of units of holding H to sell. At block 1022, the procedure 1000 sets S=(H_{R}−H_{D})/(price of H). If the procedure determines that even lots are required (block 1024), the procedure adjusts that value of S at block 1026 by setting S=Integer ((S/L)+0.5)* L. This equation adds 0.5 to round up to the next lot size. The procedure then determines whether S>U_{R} (block 1028). U_{R} is the number of units of holding H in the real investment portfolio. If S>U_{R}, then S is set to equal to U_{R} (block 1030) to avoid suggesting a sale of more units than are held in the real investment portfolio.

The procedure also checks to be sure a portion of a unit is not left as a result of executing a suggested sale. This check is performed at block 1032 where the procedure determines whether (U_{R}−S)<L. If block 1032 results in a positive determination, the procedure sets S equal to U_{R} (block 1034).

As mentioned above, procedure 1000 may restrict transactions to those that will have a significant effect on the holdings of the real investment portfolio. For example, the procedure may not suggest selling a holding unless such a sale would reduce that holding by at least a minimum percentage (D₁) or would eliminate the holding entirely. The procedure implements this restriction by continuing to block 1036 (FIG. 10C), which determines whether (S*(price of H)/H_{R})>D₁. If not, the procedure also determines whether S=U_{R} (block 1038). If the determination in either block 1036 or block 1038 is positive, the procedure suggests selling S units of holding H (block 1040). If the determinations at blocks 1036 and 1038 are both negative, then the procedure does not suggest a sale of holding H and, instead, returns to block 1018 (FIG. 10A).

In addition to determining whether we wish to buy or sell any units of the holdings that are currently in the ideal investment portfolio, a second procedure examines the real investment portfolio for holdings that are no longer in the ideal investment portfolio. FIG. 11 is a flow diagram illustrating a procedure 1100 for generating additional trades in the real portfolio to eliminate the holdings no longer in the ideal investment portfolio. Initially, the procedure selects a first holding (H) in the real investment portfolio (block 1102). The procedure then determines whether there are any units of H in the ideal investment portfolio (block 1104). If so, the procedure branches to block 1108 to determine whether there are additional holdings in the real investment portfolio. If there are no units of H in the ideal investment portfolio, the procedure suggests selling U_{R} units (i.e., all units) of holding H from the real investment portfolio (block 1106). The procedure then continues to block 1108. If there are no additional holdings in the real investment portfolio, the procedure ends. Otherwise, the procedure selects the next holding in the real investment portfolio (block 1110) and returns to block 1104.

By first creating an ideal investment portfolio and then using it to suggest trades in a real investment portfolio, changes in the real investment portfolio are decoupled from individual changes in the ideal investment portfolio. The ideal investment portfolio and the real investment portfolio may be recomputed as often as desired. Trade suggestions for the real investment portfolio can be executed at the discretion of the manager (or managers) of the real investment portfolio. If trades are suggested, but not executed yet, those trades will continue to be suggested until the ideal investment portfolio changes again or the trades are executed. If additional funds are added to the real investment portfolio, the procedure generates suggested purchases for all of the holdings in the real investment portfolio without requiring a change in the associated ideal investment portfolio. Similarly, if funds are to be removed from the real investment portfolio, the procedure generates suggested sales for all holdings in the real investment portfolio without requiring any change in the associated ideal investment portfolio.

### CONCLUSION

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
identifying a set of investment holdings associated with a first investment portfolio;
identifying a set of investment holdings associated with a second investment portfolio; and
merging the set of investment holdings associated with the first investment portfolio and the set of investment holdings associated with the second investment portfolio into an ideal investment portfolio.

2. The method of claim 1, wherein merging the investment holdings includes combining at least a portion of the investment holdings associated with the first investment portfolio and at least a portion of the investment holdings associated with the second investment portfolio.

3. The method of claim 1, wherein merging the investment holdings includes averaging the investment holdings associated with the first investment portfolio and the investment holdings associated with the second investment portfolio.

4. The method of claim 1, wherein merging the investment holdings includes applying a weighting to each investment holding associated with the first investment portfolio and each investment holding associated with the second investment portfolio.

5. The method of claim 4, wherein the weighting is applied to the investment holdings based on a momentum associated with each investment holding.

6. The method of claim 4, wherein the weighting is applied to the investment holdings based on a support level associated with each investment holding.

7. The method of claim 1, wherein merging the investment holdings includes selecting a portion of the investment holdings associated with the first investment portfolio based on a first policy and selecting a portion of the investment holdings associated with the second investment portfolio based on a second policy.

8. The method of claim 1, wherein merging the investment holdings includes selecting the top-performing investment holdings from each set of investment holdings and including the top-performing investment holdings in the ideal investment portfolio.

9. The method of claim 1, wherein the first investment portfolio is a top-performing mutual fund.

10. The method of claim 1, wherein the first investment portfolio is real or hypothetical portfolio of a top-performing investment advisor.

11. The method of claim 1, wherein the first investment portfolio is real or hypothetical portfolio of a top-performing individual investor.

12. The method of claim 1, further including modifying the ideal investment portfolio based on changes in the set of investment holdings associated with the first investment portfolio.

13. The method of claim 1, further including modifying the ideal investment portfolio based on changes in the set of investment holdings associated with the second investment portfolio.

14. The method of claim 1, further including modifying the ideal investment portfolio based on changes in the set of investment holdings associated with the first investment portfolio or changes in the set of investment holdings associated with the second investment portfolio.

15. The method of claim 1, further including modifying the ideal investment portfolio based on changes in the first investment portfolio.

16. The method of claim 1, further including modifying the ideal investment portfolio based on changes in the second investment portfolio.

17. The method of claim 1, further including modifying the ideal investment portfolio based on changes in the first or second investment portfolio.

18. One or more computer readable media storing computer-executable instructions that, when executed on one or more processors, perform the method of claim 1.

19. A method comprising:
selecting a plurality of top-performing investment portfolios;
identifying the investment holdings associated with each of the selected investment portfolios; and
merging at least a portion of the investment holdings associated with each of the selected investment portfolios to generate an ideal investment portfolio.

20. The method of claim 19, further including modifying the ideal investment portfolio based on changes in the investment holdings associated with any of the selected investment portfolios.

21. The method of claim 19, further including modifying the ideal investment portfolio based on changes in the selected investment portfolios.

22. The method of claim 19, wherein the top-performing investment portfolios are selected from a group of investment sources comprising individual investors, investment advisors, and mutual funds.

23. The method of claim 19, wherein merging the investment holdings includes selecting at least a portion of the investment holdings associated with each investment portfolio for inclusion in the ideal investment portfolio.

24. The method of claim 19, wherein merging the investment holdings includes selecting investment holdings based on a momentum associated with each investment holding for inclusion in the ideal investment portfolio.

25. The method of claim 19, wherein merging the investment holdings includes selecting investment holdings based on a support level associated with each investment holding for inclusion in the ideal investment portfolio.

26. One or more computer readable media storing computer-executable instructions that, when executed on one or more processors, perform the method of claim 19.

27. A method comprising:
identifying a first set of investment holdings associated with a first investment portfolio;
identifying a first policy associated with the first set of investment holdings;
identifying a second set of investment holdings associated with a second investment portfolio;
identifying a second policy associated with the second set of investment holdings;
merging the first set of investment holdings based on the first policy and the second set of investment holdings based on the second policy into a merged set of holdings.

28. The method of claim 27, wherein the merged set of holdings is an ideal investment portfolio.

29. The method of claim 27, wherein the first policy averages the first set of investment holdings into the merged set of holdings.

30. The method of claim 27, wherein the second policy averages the second set of investment holdings into the merged set of holdings.

31. The method of claim 27, wherein the first policy excludes particular holdings in the first set of investment holdings from the merged set of holdings.

32. The method of claim 27, wherein the second policy excludes particular holdings in the second set of investment holdings from the merged set of holdings.

33. One or more computer readable media storing computer-executable instructions that, when executed on one or more processors, perform the method of claim 27.

34. A method comprising:
identifying a plurality of holdings in an ideal investment portfolio;
analyzing each of the plurality of holdings in the ideal investment portfolio to identify specific holdings that should be traded in a real investment portfolio; and
trading the specific holdings in the real investment portfolio.

35. The method of claim 34, wherein analyzing each of the plurality of holdings includes determining whether to purchase units of each holding in the real investment portfolio.

36. The method of claim 34, wherein analyzing each of the plurality of holdings includes determining whether to sell units of each holding in the real investment portfolio.

37. The method of claim 34, wherein analyzing each of the plurality of holdings includes selling all units of each holding that does not have any units in the ideal investment portfolio.

38. The method of claim 34, wherein analyzing each of the plurality of holdings includes determining a proportionate number of units of each holding to be held in the real investment portfolio.

39. The method of claim 34, wherein trading the specific holdings includes trading even lots of each specific holding.

40. The method of claim 34, wherein trading the specific holdings includes trading a specific holding if the trade includes at least a minimum number of units.
